(19) United States
(12) Patent Application Publication
(10) Pub. No.: US 2011/0188720 A1
(43) Pub. Date: Aug. 4, 2011

(54) METHOD AND SYSTEM FOR AUTOMATED VOLUME OF INTEREST SEGMENTATION

(75) Inventors: Ajay Narayanan, Bangalore (IN); Kajoli Banerjee Krishnan, Bangalore (IN); Dattesh Dayanand Shanbhag, Bangalore (IN); Patrice Hervo, Clamart (FR); Rakesh Mullick, Bangalore (IN)

(73) Assignee: GENERAL ELECTRIC COMPANY, Schenectady, NY (US)

(21) Appl. No.: 12/698,207

(22) Filed: Feb. 2, 2010

(51) Int. Cl. G06K 9/00; G06K 9/20

(52) U.S. Cl. 382/131; 382/164

(57) ABSTRACT

Methods and systems and computer program products for automatically segmenting the volume of interest from intensity images are provided. The method for segmenting a volume of interest in an intensity image receives the intensity image and the scanner acquisition parameters used to acquire the intensity image. The method then scales the contrast of the intensity image based, at least in part, on the scanner acquisition parameters. The method segments the intensity image based, at least in part, on image data of the intensity image and the scanner acquisition parameters, to obtain the volume of interest.

### BACKGROUND

The present invention relates generally to medical imaging and more particularly to an automated segmentation methodology for intensity images acquired from medical scanners.

Various scanning techniques are used in radiology for medical imaging. Such techniques include Magnetic Resonance Imaging (MRI), Positron Emission Tomography (PET), Single Photon Emission Computed Tomography (SPECT), and the like. One similarity between such techniques is the use of bolus tracking, that is, administration of a contrast agent or radioactive tracer material to the patient. The bolus enhances the visibility of a volume of interest in the patient's body, for the medical scanner. MRI scanners apply a uniform magnetic field to the patient's body and obtain energy signals caused by the altered distribution of the orientation of magnetic moments due to the field in the volume of interest. A tracer may be used to enhance the level of alteration in the distribution of the orientation of the magnetic moments of the volume of interest. PET and SPECT scanners employ a gamma camera to scan the patient's body for nuclear radiation signals subsequent to administration of the radioactive tracer material. The energy or nuclear radiation signals are then used to construct intensity images of the patient's body.

The intensity image acquired from medical scanners needs to be segmented in order to obtain details of the volume of interest. Segmentation of a medical image, such as an intensity image, is a process of partitioning the image into multiple regions, usually to locate objects and boundaries, such as organs of the human body. A segmented intensity image can be used for various applications such as volumetry, planning of surgical resection, delineating organs, planning of radiotherapy treatment assessment of transplant donor, detection of pathology or symptoms of metabolic disorders, and the like.

Some known techniques for segmentation of intensity images usually involve operator intervention. The operator typically identifies an initial point (referred to herein as “the seed point”) in the volume of interest, and then manually controls the progression of the segmentation process. Such a segmentation process is often time consuming, tedious and prone to subjectivity with a change in the operator.

On the other hand, certain automated segmentation techniques also exist in the art. Examples of automated segmentation techniques include region growing, level sets, multi-scale segmentation, neural network segmentation, and the like. Such automated techniques use a medical image processor to segment the intensity image obtained from the medical scanner. However, the intensity and its distribution in the volume of interest in the intensity image varies across patients. Further, intensity and its distribution in the volume of interest varies with imaging modality (MRI, PET or SPECT and such like), and specifics thereof (such as magnetic field strength of MRI). The shape and the size of the volume of interest also vary across patients. Due to the foregoing reasons, current automated segmentation techniques often lack accuracy and reliability. Various known automated segmentation techniques compensate for this shortcoming to some extent by providing a manual override functionality to permit intervention by the operator. Therefore, there is a need in the art for a method and a system for providing more accurate and reliable automated segmentation of intensity images.

### BRIEF DESCRIPTION

The above and other drawbacks/deficiencies of the conventional systems may be overcome or alleviated by an embodiment of a method for automatically segmenting the volume of interest from intensity images. One embodiment is a method for segmenting a volume of interest in an intensity image that receives the intensity image and the scanner settings are used to acquire the intensity image (referred to herein as “the acquisition parameters”.) The method then scales the contrast of the intensity image based, at least in part, on the acquisition parameters. The method segments the intensity image based, at least in part, on image data of the intensity image and the acquisition parameters, to obtain the volume of interest.

### DRAWINGS

These and other features, aspects, and advantages of the present system and techniques will become better understood when the following detailed description is read with reference to the accompanying drawings in which like characters represent like parts throughout the drawings, wherein:

FIG. 1 is a schematic block diagram of a Magnetic Resonance (MR) imaging system for use in conjunction with various embodiments of the present system;

FIG. 2 is a flowchart illustrating an exemplary process of automated segmentation of a volume of interest from an intensity image, using acquisition parameters, in accordance with various embodiments;

FIG. 3 is a flowchart illustrating an exemplary process of automated segmentation of a volume of interest from an intensity image, using acquisition parameters, in accordance with various embodiments;

FIG. 4 illustrates the input intensity image in accordance with various embodiments;

FIG. 5 illustrates the seed for segmentation of the volume of interest from the intensity images in accordance with various embodiments;

FIG. 6 illustrates the spherical wavefronts centered at the seed in accordance with various embodiments;

FIG. 7 illustrates the smoothened intensity image in accordance with various embodiments;

FIG. 8 illustrates the image obtained from a gradient operation in accordance with various embodiments;

FIG. 9 illustrates the contrast scaled intensity image in accordance with various embodiments;

FIG. 10 illustrates the intensity image displaying the region grown by the geodesic active contours in accordance with various embodiments;

FIG. 11 illustrates the iterative refinement of level sets in accordance with various embodiments;

FIG. 12 illustrates a user interface for real-time display of the progress of the segmentation process, in accordance with various embodiments; and

FIG. 13 illustrates exemplary curves of the sigmoid function, in accordance with various embodiments.

### DETAILED DESCRIPTION

Various embodiments describe processes for automated volume of interest segmentation from intensity images, using image acquisition parameters. The use of acquisition parameters for the automated segmentation of the volume of interest provide robust automated segmentation while accounting for variations in the contrast of the intensity images from patient to patient, and across different imaging systems and scanners. While the following specification describes various embodiments with reference to a Magnetic Resonance Imaging system, the teachings may be used for segmentation of other types of scans without limitation, for example, PET scans, SPECT scans, and the like.

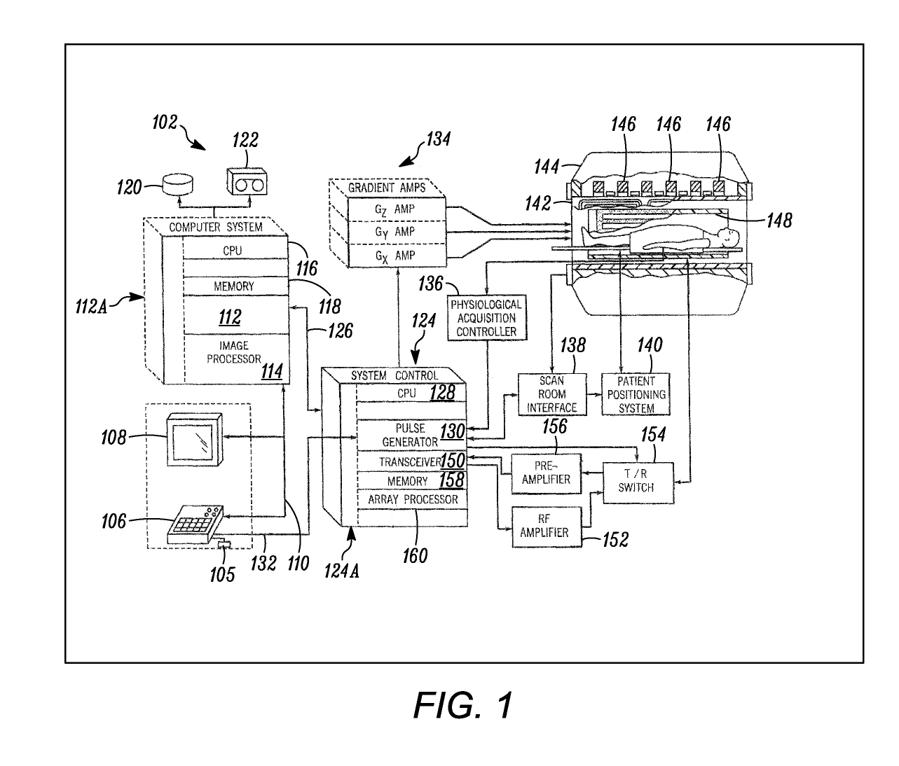

Referring to FIG. 1, the major components of an exemplary magnetic resonance imaging (MRI) system 102 benefiting from incorporating the present system are shown. The operation of the system 102 is controlled from an operator console, which includes a keyboard or other input device 105, a control panel 106, and a display screen 108. The operator console communicates through a link 110 with a separate computer system 112 that enables an operator to control the production and display of images on the display screen 108. The computer system 112 includes a number of modules which communicate with each other through a backplane 112A. These include an image processor module 114, a CPU module 116 and a memory module 118, known in the art as a frame buffer for storing image data arrays. The computer system 112 is linked to disc storage 120 and tape drive 122 for storage of image data and programs, and communicates with a separate system control 124 through a high speed serial link 126. The input device 105 can include a mouse, joystick, keyboard, track ball, touch activated screen, light wand, voice control, or any similar or equivalent input device, and may be used for interactive geometry prescription.

The system control 124 includes a set of modules connected together by a backplane 124A. These include a CPU module 128 and a pulse generator module 130 which connects to the operator console through a serial link 132. It is through link 132 that the system control 124 receives commands from the operator to indicate the scan sequence that is to be performed. The pulse generator module 130 operates the system components to carry out the desired scan sequence and produces data which indicates the timing, strength and shape of the RF pulses produced, and the timing and length of the data acquisition window. The pulse generator module 130 connects to a set of gradient amplifiers 134, to indicate the timing and shape of the gradient pulses that are produced during the scan. The pulse generator module 130 can also receive patient data from a physiological acquisition controller 136 that receives signals from a number of different sensors connected to the patient, such as ECG signals from electrodes attached to the patient. And finally, the pulse generator module 130 connects to a scan room interface circuit 138 which receives signals from various sensors associated with the condition of the patient and the magnet system. It is also through the scan room interface circuit 138 that a patient positioning system 140 receives commands to move the patient to the desired position for the scan.

The gradient waveforms produced by the pulse generator module 130 are applied to the gradient amplifier system 134 having Gx, Gy, and Gz amplifiers. Each gradient amplifier excites a corresponding physical gradient coil in a gradient coil assembly generally designated 142 to produce the magnetic field gradients used for spatially encoding acquired signals. The gradient coil assembly 142 forms part of a magnet assembly 144 which includes a polarizing magnet 146 and a whole-body RF coil 148. A transceiver module 150 in the system control 124 produces pulses which are amplified by an RF amplifier 152 and coupled to the RF coil 148 by a transmit/receive switch 154. The resulting signals emitted by the excited nuclei in the patient may be sensed by the same RF coil 148 and coupled through the transmit/receive switch 154 to a preamplifier 156. The amplified MR signals are demodulated, filtered, and digitized in the receiver section of the transceiver 150. The transmit/receive switch 154 is controlled by a signal from the pulse generator module 130 to electrically connect the RF amplifier 152 to the coil 148 during the transmit mode and to connect the preamplifier 156 to the coil 148 during the receive mode. The transmit/receive switch 154 can also enable a separate RF coil (for example, a surface coil) to be used in either the transmit mode or the receive mode.

The MR signals picked up by the RF coil 148 are digitized by the transceiver module 150 and transferred to a memory module 158 in the system control 124. A scan is complete when an array of raw k-space data has been acquired in the memory module 158. This raw k-space data is rearranged into separate k-space data arrays for each image to be reconstructed, and each of these is input to an array processor 160 which operates to Fourier transform the data into an array of image data. This image data is conveyed through the serial link 126 to the computer system 112 where it is stored in memory, such as disc storage 120. In response to commands received from the operator console, this image data may be archived in long term storage, such as on the tape drive 122, or it may be further processed by the image processor 114 and conveyed to the operator console and presented on the display 108.

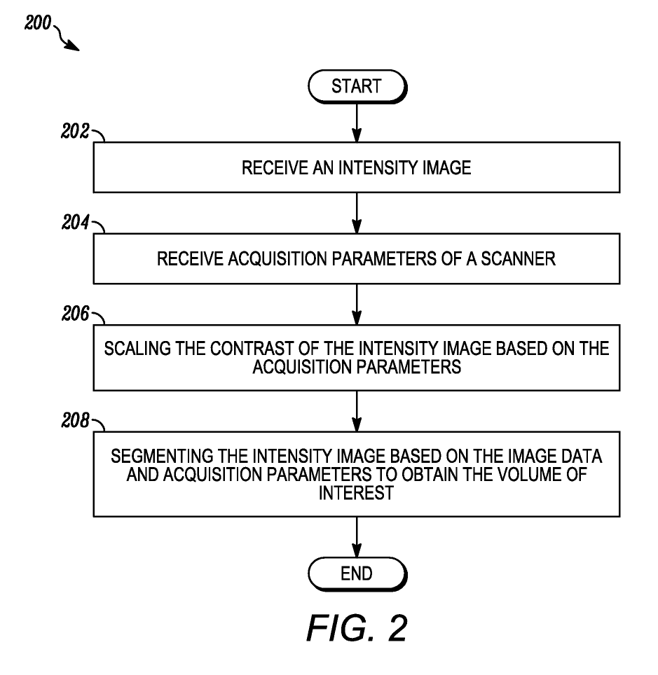

FIG. 2 is flowchart illustrating an exemplary process of automated segmentation of a volume of interest from an intensity image, using acquisition parameters, in accordance with various embodiments.

At step 202, the image processor module 114 receives an intensity image. In an exemplary embodiment, the image processor module 114 receives the intensity image from the magnetic resonance scanner. In another embodiment, the intensity image may be stored in a data storage device such as the disc storage 120 or the tape drive 122, connected to the computer system 112. The intensity images may have been acquired by the MR scanner previously and stored in the disc storage 120 or the tape drive 122. Alternatively, the intensity images may have been acquired from another MR scanner, received through a network such as the internet or portable storage media such as, but not limited to, optical discs, portable hard disc drives, flash memory devices and the like. In an exemplary embodiment, the intensity image may be a part of a Digital Imaging and Communications in Medicine (DICOM) object.

At step 204, the image processor module 114 receives the image acquisition parameters of the scanner. The acquisition parameters include one or more of an echo time (TE), a repetition time (TR), the number of coils of a magnetic resonance scanner, coil settings, and the number of scan image averages considered. In an exemplary embodiment, the acquisition parameters may be stored in the DICOM tags of the DICOM object that contains the intensity images. The acquisition parameters may be stored in public DICOM tags. The public tags may be accessed by any scanner, thus providing inter-operability. Alternatively, the acquisition parameters may be stored in private DICOM tags. The private DICOM tags may be accessed only by the scanners or image viewers that are authorized to access the DICOM image data. The assessment of a patient's response to therapy over time may necessitate the loading of intensity images acquired from a particular scanner, to different scanners at different clinical sites, at different times. In such a scenario, the use of DICOM tags to store the acquisition parameters may yield consistent tracking of the patient's response to therapy.

At step 206, the image processor module 114 scales the contrast of the intensity image based on the acquisition parameters. The image processor 114 may use a contrast scaling function to enhance the contrast of the intensity image. In other words, the contrast scaling function brightens the bright regions of and darkens the dark regions of the intensity image. The image processor module 114 may adjust parameters such as, but not limited to, a threshold, a transition slope and a scale factor, of the contrast scaling function based on the acquisition parameters.

In an example implementation of liver segmentation, the MR scanner may use short TE and short TR times to acquire a T1-weighted intensity image. For given TE and TR times, a range of signal intensities of the liver, and a range of signal intensities for the neighboring tissues may be known. The image processor module 22 may then use the contrast scaling function to brighten the voxels of the intensity image which have intensities within the range of signal intensities of the liver, and darken the voxels of the intensity image which have intensities within the range of the signal intensities of the neighboring tissues.

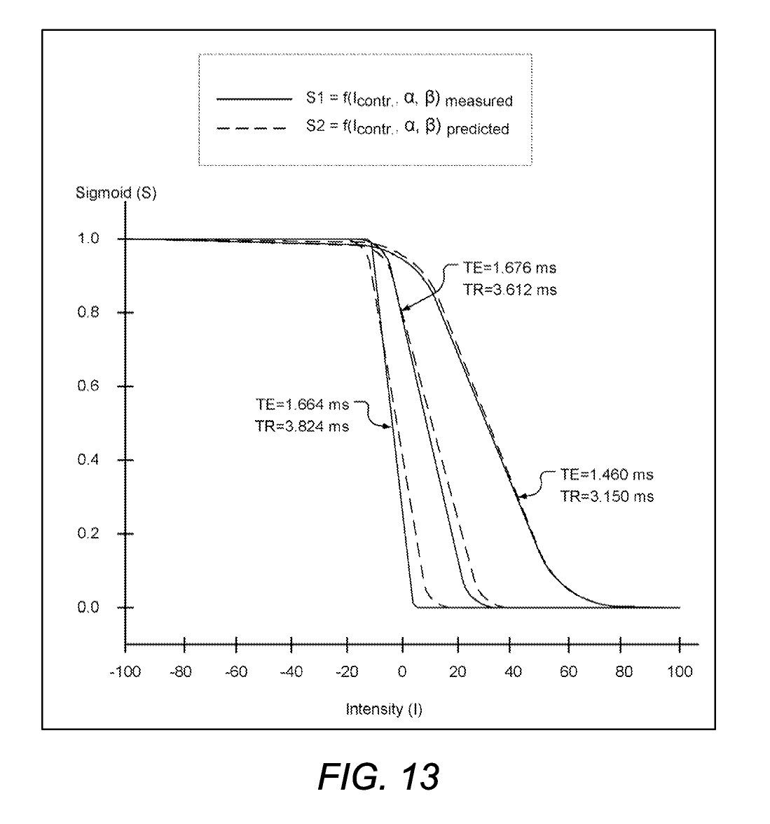

Level sets used to perform the segmentation are initialized using a feature image that may be derived by preprocessing of the original image. The property of a “well formed” feature image is that it enhances the propagation of the levelsets in the homogeneous regions and rapidly slows down the propagation in the region boundaries. In an exemplary embodiment, the image processor module 114 uses a sigmoid function to scale the contrast of at least a portion of the intensity image in the vicinity of the estimated level set. An exponential sigmoid transfer function may provide enhancement to a gradient magnitude image to form such a feature image. The sigmoid function increases the response in the homogeneous regions and rapidly drops to zero on high gradient regions. The sigmoid function directly affects the performance of the subsequent level set computations. For automation of the segmentation process, the system may predict the parameters of the sigmoid function to increase the robustness of segmentation. In general, image statistics within region of interest for example, the liver, and outside region of interest may be used to compute α and β that characterize the sigmoid function. Based on empirical observation and regression, a predictive equation based on TE and TR can be used in lieu of image statistics to estimate the sigmoid parameters. A sigmoid function is defined by a centre, a bandwidth around the centre, and a slope. These parameters of the contrast-scaling sigmoid function may be adjusted based on the acquisition parameters, to scale the contrast of the intensity image. Exemplary sigmoid functions are illustrated in FIG. 13, for three separate values of TE and TR. It has been experimentally observed that the hybrid parameter:

$${T}_{acq .} = ( \frac{TR}{TE} + TE ) \qquad Equation 1$$

has a strong correlation with image intensity statistics. The image intensity statistics that describe the organ of interest are the major classes of tissues belonging to the background (K₀), body (K₁) and the organ of interest, Liver (K₂) that can be summed up into a lumped parameter I_{contr} given as

I_{contr.}^{MEAS}=K₂+(K₂−K₁) Equation 2

The above equation can be understood as the mean intensity of the organ of interest (K₂) compounded with the average contrast it has to the soft-tissues neighboring it (K₂−K₁) in the histogram space. These can be statistically computed from the analysis of the image histogram. In the current work these are computed using the K-Means clustering technique applied on the whole 3D Image data. The transfer function obtained by the regression analysis (two parameter model) leads to the following predictive function:

I_{contr.}^{PRED}=4.73×10⁴−1.16×10⁴T_{acq.} Equation 3

(R²=0.954). The importance of predictive contrast measurement is highlighted by the fact that the parameter settings of the sigmoid filter are derived from this contrast value. While Equation 3 is representative of the image contrast in accordance with one embodiment, in other embodiments, such transfer functions can be derived for various contrast mechanisms achieved through MRI, for example T1, T2, PD, T1-Contrast Enhanced, DWI, DTI, and so forth.

Thus I_{trans.}=ƒ(I₀,TE,TR,Tiss−Quant,flipangle,B₀) Equation 4

where:
Tiss-Quant=Tissue specific MRI parameters such as T2, T1, PD, Apparent Diffusion Coefficient, Fractional Anisotropy, and so forth;
I₀=Base Image intensity; and
B₀=MR Field strength.

Additionally, the regression for the parameters are as follows:

α=2.7−2.4×10⁻¹.I_{contr.} Equation 5

(R²=0.995). The beta parameter may be defined as:

β=−3α Equation 6.

The correlation of I_{contr.}^{MEAS} [symbol] I_{contr.}^{PRED} builds confidence in the parameter setting process.

The contrast scaling results in a substantially homogenous bright region corresponding to the volume of interest, and a substantially homogenous dark region corresponding to regions outside the volume of interest. Further, the contrast scaling also results in a large difference in intensities of the bright region and the dark region. Such intensity characteristics of the intensity image aid automated segmentation. In an exemplary embodiment where the automated segmentation may be performed using level set techniques, such a contrast scaled intensity image may provide a smooth field of growth for the level sets within the volume of interest, while providing large intensity differences at the boundary of the volume of interest to halt the progression of the level sets.

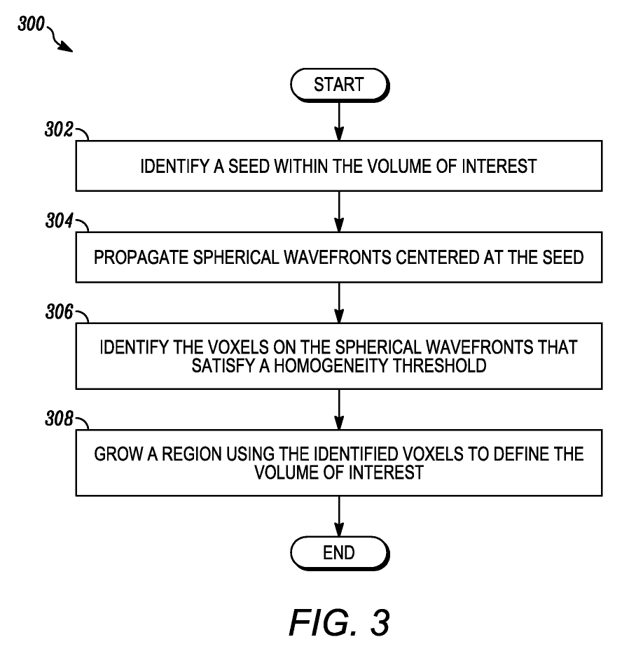

At step 208, the image processor module 114 segments the intensity image based on the image data and the acquisition parameters to obtain the volume of interest. In an exemplary embodiment, the image processor module 114 segments the volume of interest using an active contours technique. The active contours technique includes identifying a seed point, and propagating a spherical wavefront outwards, inside the volume of interest, until the sphere reaches the desired boundary. The image processor module 114 may propagate the spherical wavefront taking into account the image data and the acquisition parameters. Such a segmentation process using the active contours technique is described in conjunction with FIG. 3.

The variations in contrast of intensity images between patients, between scanners, and between different choices of acquisition parameters have previously limited the robust automation of the segmentation of the volume of interest. The segmentation algorithm for automated volume of interest described above considers the acquisition parameters of the scanner while segmenting the intensity images.

FIG. 3 is flowchart illustrating an exemplary process of automated segmentation of a volume of interest, from an intensity image, using acquisition parameters, in accordance with various embodiments.

The seed is identified within the volume of interest at step 302. Said differently, step 302 may be termed as the automatic volume of interest process (referred to herein as Auto VOI). The auto VOI process receives as input, intensity images of a larger body volume containing the volume of interest. For example, the auto VOI process receives the intensity images of an abdominal cavity for analyzing the liver. Image processor module 114 profiles the 3D intensity images in orthogonal axes along x, y, and z direction, to obtain the 2D intensity profiles of the intensity images. The intensity profiles are the summation of the integral value of the intensity of the voxels along a ray which passes through the volume of interest. The image processor module 114 collapses the 2D intensity profiles into 1D intensity profiles. In other words, the image processor module 114 takes a profile of the 2D intensity profile. The image processor module 114 identifies the volume of interest as the region projecting a very high summation of voxel intensity. Thus, by analyzing the intensity profiles, the image processor module 114 may decide where to chop-off the volume and retain the volume of interest. In various embodiments, the auto VOI process may be accompanied by the K-means clustering technique in order to obtain estimates for the intensity distribution of the background (air), the volume of interest and the neighboring soft tissues. The image processor module 114 may then place the seed within the identified volume of interest.

At step 304, the image processor module 114 propagates a spherical wavefront centered at the seed. The image processor module 114 propagates the spherical wavefront on the contrast scaled intensity images, to segment the volume of interest. The image processor module 114 may employ geodesic active contours to propagate the spherical wavefront on the intensity images. Geodesic active contours are level sets, the propagation of which is defined by an intensity growth parameter, a gradient growth parameter and a curvature growth parameter of the contrast scaled intensity image. The three growth parameters are partly dependant on the image data and may partly be controlled by the acquisition parameters. The growth parameters are PropagationScaling, CurvatureScaling and AdvectionScaling. The growth parameters are functions of an image resolution or grid size. At a lower grid size, 32×32 voxels for example, the value of the PropagationScaling may be as high as 12 while dropping to 10 for a grid size of 256×256 voxels. For a small grid size, the number of iterations is kept high (˜1200), and is reduced for a large grid-size. This is done because it takes much less time to fine-tune the segmentation estimate already obtained at a lower resolution level that corresponds to a larger grid size.

At step 306, one or more voxels are identified on the spherical wavefronts satisfying the homogeneity threshold. The homogeneity threshold is the intensity difference between the voxels on successive spherical wavefronts. The spherical wavefront may propagate quickly in regions of homogenous intensity. In other words, the spherical wavefront may propagate quickly in regions where the voxels on the spherical wavefronts satisfy the homogeneity threshold. However, the moment that the spherical wavefront encounters a boundary of the volume of interest i.e. the region where the voxels on the spherical wavefronts no longer satisfy the homogeneity threshold, the propagation of the spherical wavefront halts at that point. The homogeneity threshold defines the intensity difference between voxels in successive spherical wavefronts at which the propagation of the spherical wavefront should be halted. The voxels that do not satisfy the homogeneity threshold may form the boundary of the volume of interest.

If there is only a small gradient from the volume of interest to its surrounding region, a portion of the volume of interest may blend into the surrounding region. However, if there is a sufficient amount of gradient in the surrounding region, the curvature term of the active contours may ensure that the spherical wavefront do not propagate through such a region. Therefore, the growth parameters of the active contours ensure that region of interest is identified even in the absence of the background.

At step 308, a region is grown using the identified one or more voxels, wherein the region defines the volume of interest. The voxels on each spherical wavefront that satisfy the homogeneity threshold may form a part of the volume of interest. Thus all voxels on the propagation spherical wavefront satisfying the homogeneity threshold results in growing of a region from the seed, and eventually taking the shape of the volume of interest, as the spherical wavefront propagates through the intensity images. The voxels that satisfy the homogeneity threshold may be tagged as part of the volume of interest. The image processor module 114 collates all such voxels tagged as part of the volume of interest, to form the segmentation of the volume of interest.

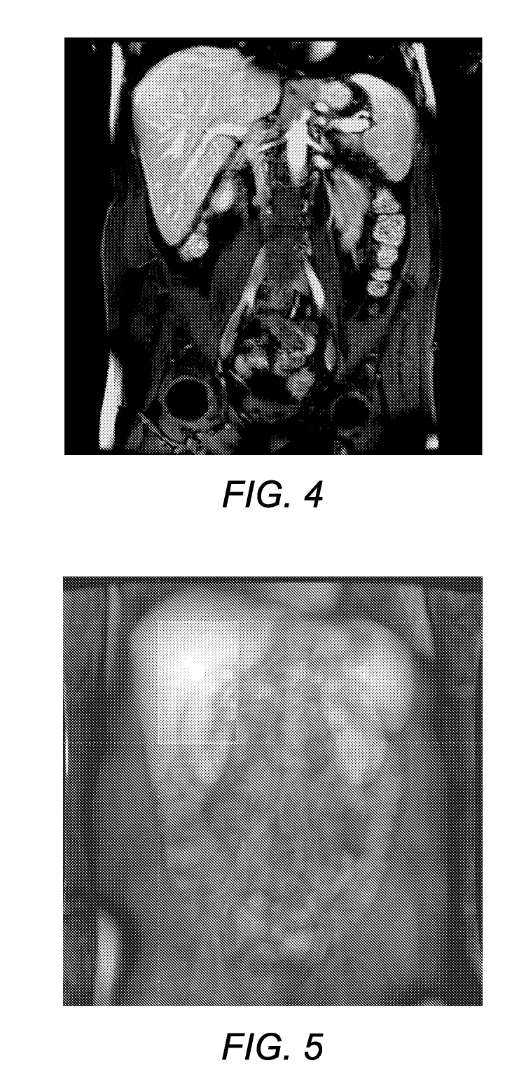

Another important step in the process of segmentation is the Multi-Resolution Framework. Sometimes it may happen that certain regions in the volume of interest are not brightened by the contrast and show up as a dark sub-region in the volume of interest. Potentially, this region can be called as a background but it is actually a part of the foreground. Thus, to get rid of the voxels where the spherical wavefront has not marched into the vascular regions, the volume is sub-sampled to ensure that all internal regions of the volume of interest are also included and thus achieve accurate segmentation of the volume of interest. Multi-resolution framework is an iterative process which provides a feedback mechanism to refine the initial estimates obtained at lower resolutions at every higher resolution step. The progression of the above steps is explained in conjunction with FIG. 4-11.

FIGS. 4-11, illustrate the intensity image at various steps in the automated segmentation process, in accordance with various embodiments.

FIG. 4 illustrates an example of the input intensity image received at the image processor module 114. This input intensity image is processed further to obtain the volume of interest.

FIG. 5 illustrates an example of the seed for segmentation of the volume of interest from the intensity images. The seed is located within the volume of interest with the help of the Auto VOI process. The Auto VOI process is explained in detail in conjunction with FIG. 3.

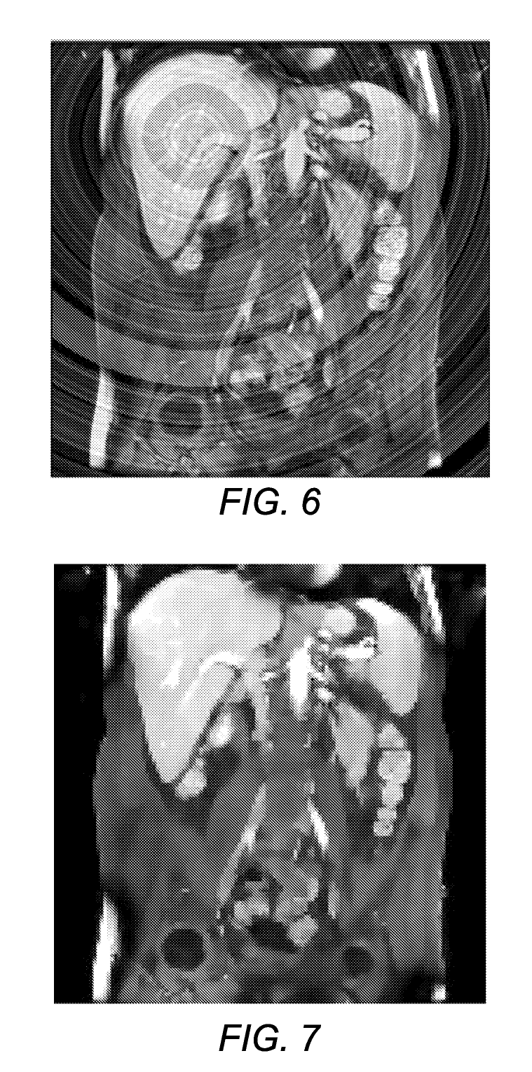

FIG. 6 illustrates the spherical wavefronts centered at the seed, resulting from a fast-marching technique. In the fast marching technique, a distance map is created around the seed in a spherical zone where every point corresponds to a unique distance i.e. a fixed integral distance from the seed in term of numerical values. These numerical values correspond to the distance of the spherical wavefront from the seed. Thus, the output of this step is the concentric spherical wavefronts with numerical values on them. The spherical wavefronts are known as estimated level sets, the numerical values indicating the distance of the estimated level set from the seed. The image processor module 114 may use the estimated level sets in an iterative refinement process employing active contours to accurately segment the volume of interest.

Once the estimated level sets are determined, the image processor module 114 may process the intensity images for refinement of the estimated level sets, to accurately segment the volume of interest from the intensity image. The image processor module 114 may first apply a shrink operator to remove discontinuities in the contour and to reduce the effect of noise in the intensity image. The shrink operation completes or fills the discontinuities in the contours. Subsequent to the shrink operator, the image processor module 114 may perform smoothening operations on the intensity images. FIG. 7 illustrates the smoothened intensity image. The smoothing operation removes the effect of noise induced during the acquisition of the intensity image and may produce an image with smooth boundaries.

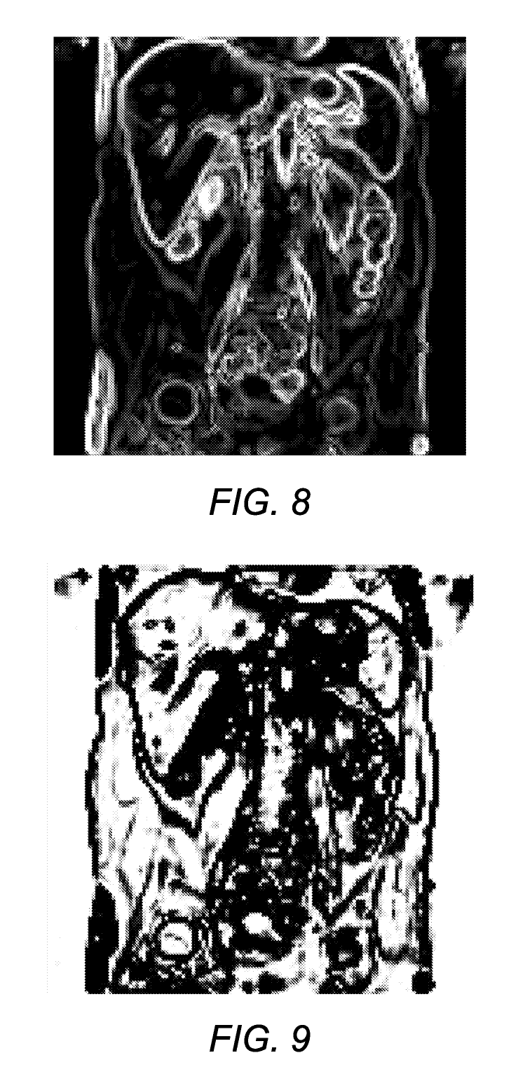

The image processor module 114 then performs a gradient operation on the smoothened intensity image. FIG. 8 illustrates the image obtained from a gradient operation. In an exemplary embodiment, the gradient operation is performed using a gradient recursive Gaussian operator. The gradient operation is used to detect the edges i.e. the boundary of the volume of interest in the smoothened intensity image.

The image processor module 114 scales the contrast of the smoothened intensity image using a sigmoid function. FIG. 9 illustrates the contrast scaled intensity image. The sigmoid function rescales the contrast of the intensity image in order to obtain a smooth field of growth of the spherical wavefronts in the volume of interest.

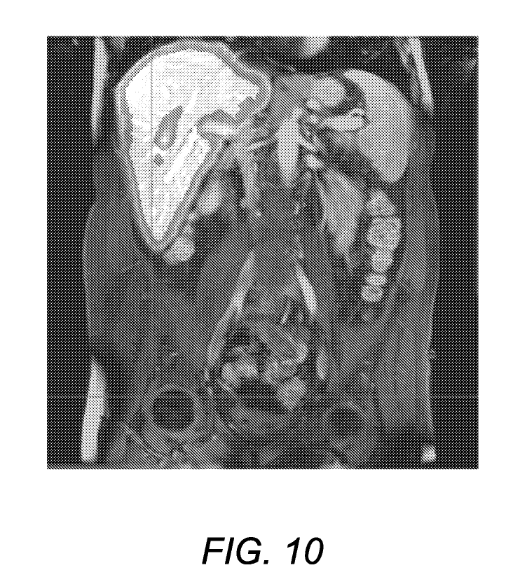

The image processor module 114 runs the estimated level sets on the contrast scaled intensity image. In an exemplary embodiment, the estimated level sets are run on the contrast scaled intensity image using geodesic active contours. FIG. 10 illustrates the intensity image displaying the region grown by the geodesic active contours. The process of using geodesic active contours to grow the region is described in conjunction with FIG. 3. The region grown represents the segmentation of the volume of interest from the intensity images.

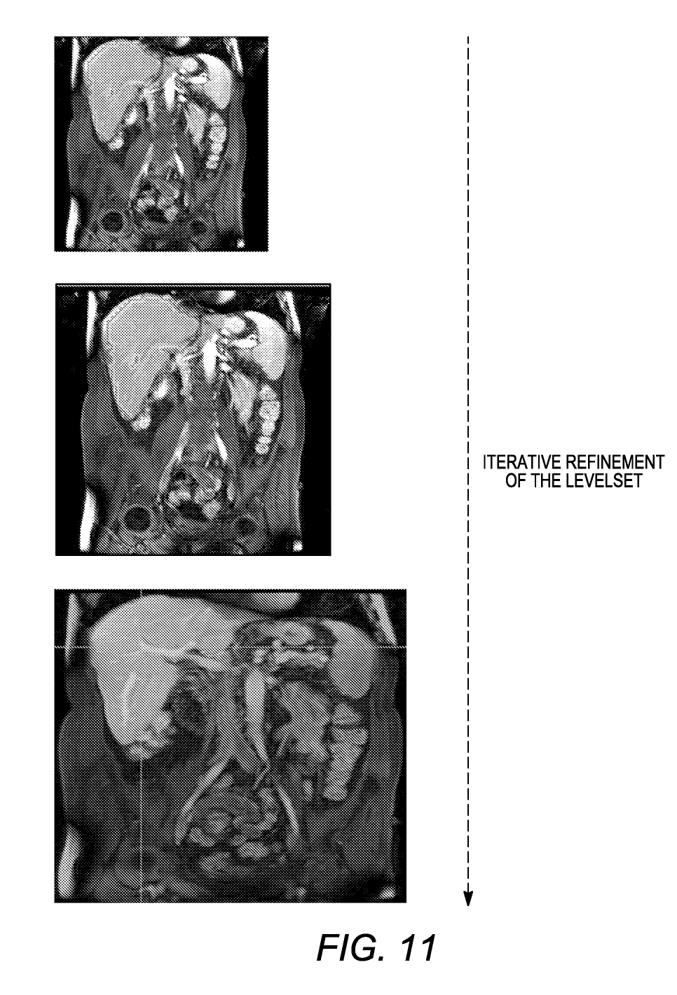

FIG. 11 illustrates the process of iterative refinement of level set. This process is known as the Multi-resolution framework. In this process the volume is sub-sampled to ensure that all internal regions of the volume of interest are also covered-up, thus obtaining accurate segmentation results. Multi-resolution framework is an iterative process which keeps feeding itself for higher resolution and refines the initial estimates of the lower resolution frame work.

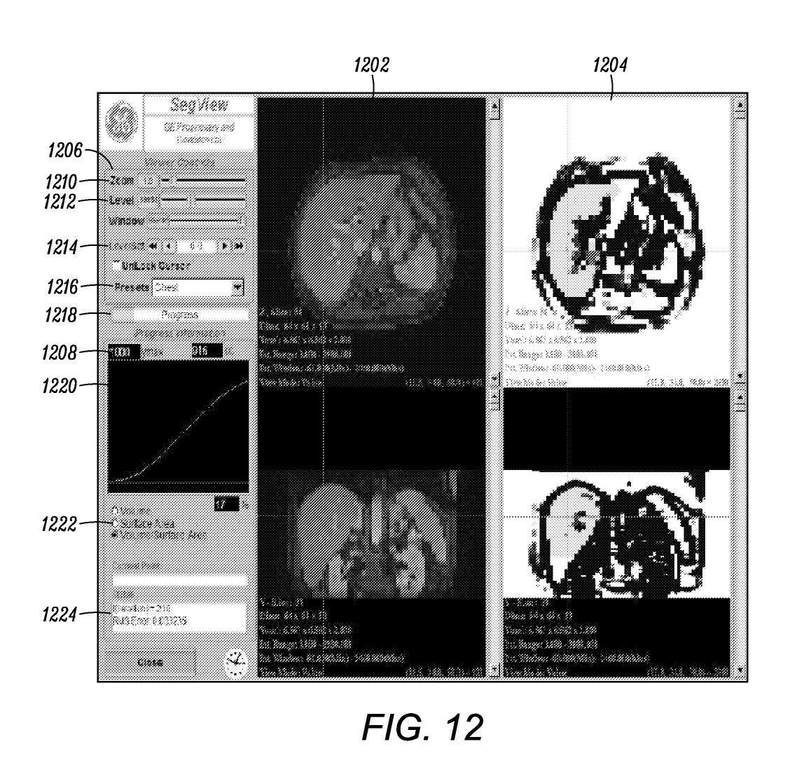

FIG. 12, illustrates a user interface for real-time display of the progress of the segmentation process, in accordance with various embodiments.

The user interface 1200 provides a real-time display and a feedback mechanism while the algorithm is executing. The user interface 1200 is a stand alone front end viewer that presents the user the instantaneous segmentation states, computes and reports volume/surface area on real-time as the algorithm evolves the seed volume in the volume of interest. The user interface 1200 includes a segmentation window 1202, an energy image window 1204, a viewer control panel 1206 and a progress indicator 1208.

The segmentation window 1202 displays the step-by-step progress of the segmentation, whether the algorithm is actually segmenting the volume of interest or leaking or not propagating. The window 1202 displays the original image and the segmentation overlay, as the segmentation process proceeds. The energy image window 1204 displays the energy image i.e. the contrast scaled intensity image, scaled using the sigmoid function.

The viewer control panel 1206 allows the user to step through the segmentation process. The viewer control panel 1206 includes a zoom control 1210, a window-level fine tune control 1212, a level set control 1214 and a presets selector 1216. The zoom control 1210 allows the user to view the images with a desired magnification level. The window-level fine tune control 1212 allows the user to incrementally adjust the contrast levels of the data—being displayed. The level set control 1214 allows the user to change the level set being displayed. Generally, the 0^{th} level set is the actual segmentation level and the other level sets are potentially a part of the volume of interest. Thus, the user can also view the images of the other level sets. The preset selector 1216 allows the selection of contrast window-level presets corresponding to the region of the body in which the volume of interest is located. For example, to view the liver as the volume of interest, the Chest preset may be selected.

The progress indicator 1208 displays the total percentage of segmentation completed. In an exemplary embodiment, the progress indicator 1208 includes a progress indicator bar 1218. The progress indicator 1208 may further include a volume of interest quantification tracker 1220, a quantification selector 1222 and a status area 1224. The quantification tracker 1220 displays the volume of interest quantification as a function of segmentation progress. The quantification selector 1222 allows the user the option to select the quantification to be displayed, such as, the volume, the surface area or the volume to surface area ratio. The status area 1224 displays the iteration number and the RMS error associated with the iteration.

The interface 1200 displays the progress of the segmentation process in real time. The display provides a visual feedback on evolutionary performance of the automated volume of interest segmentation system and allows manual intervention as well. The operator may pause or terminate the evolution based on the specific clinical requirement.

Although various embodiments of the present invention consider the example of segmenting the liver, the automated volume of interest segmentation algorithm may be applied to other tissues of the body as well. Further, the automated volume of interest segmentation algorithm and real-time display system may also be combined with pharmaco-kinetic models to segment and classify tumors. In some embodiments, a sub-segmentation of the volume of interest may be performed to identify tumors within specific tissues. To state in other words, the automated volume of interest segmentation algorithm may be applied to any type of intensity images, not limited to magnetic resonance imaging. The process of considering the acquisition parameters along with the image data to control the segmentation process, accounts for variations inherent from one patient to another, and variations introduced by the different medical scan equipment.

The disclosed methods can be embodied in the form of computer or controller implemented processes and apparatuses for practicing these processes. These methods can also be embodied in the form of computer program code containing instructions embodied in tangible media, such as floppy diskettes, CD-ROMs, hard drives, and the like, wherein, when the computer program code is loaded into and executed by a computer or controller, the computer becomes an apparatus for practicing the method. The methods may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the method. When implemented on a general-purpose microprocessor, the computer program code segments configure the microprocessor to create specific logic circuits.

The technical and scientific terms used herein have the same meaning as is commonly understood by one of skill in the art to which the invention belongs, unless specified otherwise. The terms “first”, “second”, and the like used herein, do not denote any order or importance, but rather are used to distinguish one element from another. Also, the terms “a” and “an” do not denote a limitation of quantity, but rather denote the presence of at least one of the referenced item.

While the invention has been described in considerable detail with reference to a few exemplary embodiments only, it will be appreciated that it is not intended to limit the invention to these embodiments only, since various modifications, omissions, additions and substitutions may be made to the disclosed embodiments without materially departing from the scope of the invention. In addition, many modifications may be made to adapt to a particular situation or an installation, without departing from the essential scope of the invention. Thus, it must be understood that the above invention has been described by way of illustration and not limitation. Accordingly, it is intended to cover all modifications, omissions, additions, substitutions or the like, which may be included within the scope and the spirit of the invention as defined by the claims.

What is claimed is:

1. A method for segmenting a volume of interest in an intensity image, the method comprising:
receiving the intensity image;
receiving acquisition parameters of a scanner used to acquire the intensity image;
scaling contrast of the intensity image based, at least in part, on the acquisition parameters; and
segmenting the intensity image based, at least in part, on image data of the intensity image and the scanner acquisition parameters, to obtain the volume of interest.

2. The method of claim 1 wherein the intensity image is a magnetic resonance (MR) image.

3. The method of claim 1 wherein the scanner acquisition parameters comprise one or more of an echo time (TE), a repetition time (TR), the number of coils of a magnetic resonance scanner, coil settings, and the number of scan image averages taken for noise removal.

4. The method of claim 1 wherein the intensity image is a Digital Imaging and Communications in Medicine (DICOM) object and the scanner acquisition parameters are stored in one or more DICOM tags associated with the DICOM object.

5. The method of claim 1 wherein the contrast of the intensity image is scaled using a sigmoid function, wherein one or more parameters of the sigmoid function are adjusted based on the scanner acquisition parameters.

6. The method of claim 1 further comprising accepting inputs from an operator for controlling the segmenting of the intensity image.

7. The method of claim 1 wherein the segmenting comprises:
identifying a seed point within the volume of interest;
propagating a spherical wavefront centered at the seed point, wherein propagation of the spherical wavefront is based, at least in part, on the scanner acquisition parameters;
identifying one or more voxels, on the spherical wavefronts, satisfying a homogeneity threshold, wherein the homogeneity threshold is based, at least in part, on the scanner acquisition parameters; and
growing a region using the identified one or more voxels, wherein the region defines the volume of interest.

8. The method of claim 7 further comprising displaying the growth of the region in real-time.

9. A system for segmenting a volume of interest in an intensity image, the system comprising:
one or more network interfaces;
one or more processors;
a memory; and
computer program code stored in a computer readable storage medium, wherein the computer program code, when executed, is operative to cause the one or more processors to:
receive the intensity image;
receive acquisition parameters of the scanner used to acquire the intensity image;
scale contrast of the intensity image based, at least in part, on the acquisition parameters; and
segment the intensity image based, at least in part, on image data of the intensity image and the scanner acquisition parameters, to obtain the volume of interest.

10. The system of claim 9 wherein the intensity image is a magnetic resonance (MR) image.

11. The system of claim 9 wherein the scanner acquisition parameters comprise an echo time (TE), a repetition time (TR), the number of coils of a magnetic resonance scanner, coil settings, and the number of scan image averages taken for noise removal.

12. The system of claim 9 wherein the intensity image is a Digital Imaging and Communications in Medicine (DICOM) object and the scanner acquisition parameters are stored in one or more DICOM tags associated with the DICOM object.

13. The system of claim 9 wherein the contrast of the intensity image is scaled using a sigmoid function, wherein one or more parameters of the sigmoid function are adjusted based on the scanner acquisition parameters.

14. The system of claim 9 wherein the computer program code is further operative to accept inputs from an operator for controlling the segmenting of the intensity image.

15. The system of claim 9 wherein the computer program code is further operative to cause the one or more processors to:
identify a seed point within the volume of interest;
propagate a spherical wavefront centered at the seed point, wherein propagation of the spherical wavefront is based, at least in part, on the scanner acquisition parameters;
identify one or more voxels, on the spherical wavefronts, satisfying a homogeneity threshold, wherein the homogeneity threshold is based, at least in part, on the scanner acquisition parameters; and
grow a region using the identified one or more voxels, wherein the region defines the volume of interest.

16. The system of claim 15 wherein the computer program code is further operative to cause the one or more processors to display the growth of the region in real-time.

17. A computer program product comprising a computer readable medium encoded with computer-executable instructions for segmenting a volume of interest in an intensity image, the computer-executable instructions, when executed, cause one or more processors to:
receive the intensity image;
receive acquisition parameters of a scanner used to acquire the intensity image;
scale contrast of the intensity image based, at least in part, on the acquisition parameters; and
segment the intensity image based at least in part on image data of the intensity image and the scanner acquisition parameters, to obtain the volume of interest.

18. The computer program product of claim 17 wherein the intensity image is a magnetic resonance (MR) image.

19. The computer program product of claim 17 wherein the scanner acquisition parameters comprise an echo time (TE), a repetition time (TR), the number of coils of a magnetic resonance scanner, coil settings, and the number of scan image averages taken for noise removal.

20. The computer program product of claim 17 wherein the intensity image is a Digital Imaging and Communications in Medicine (DICOM) object and the scanner acquisition parameters are stored in one or more DICOM tags associated with the DICOM object.

21. The computer program product of claim 17 wherein the contrast of the intensity image is scaled using a sigmoid function, wherein one or more parameters of the sigmoid function are adjusted based on the scanner acquisition parameters.

22. The computer program product of claim 17 further comprising computer executable instructions operable to cause the one or more processors to accept inputs from an operator for controlling the segmenting of the intensity image.

23. The computer program product of claim 17 further comprising computer-executable instructions operable to cause the one or more processors to:
identify a seed point within the volume of interest;
propagate a spherical wavefront centered at the seed point, wherein propagation of the spherical wavefront is based, at least in part, on the acquisition parameters;
identify one or more voxels, on the spherical wavefronts, satisfying a homogeneity threshold, wherein the homogeneity threshold is based, at least in part, on the acquisition parameters; and
grow a region using the identified one or more voxels, wherein the region defines the volume of interest.

24. The computer program product of claim 17 further comprising computer-executable instructions operable to cause the one or more processors to display the growth of the region in real-time.
